(19) United States
(12) Patent Application Publication
(10) Pub. No.: US 2006/0012474 A1
(43) Pub. Date: Jan. 19, 2006

(54) People-locating system and method used in stationary environment utilizing ultra wideband technology

(75) Inventors: Shih-Nan Lu, Hsi Chih City (TW); Fun Ye, Taipei Hsien (TW); Yang-Han Lee, Chung Li City (TW)

Correspondence Address: TROXELL LAW OFFICE PLLC, SUITE 1404, 5205 LEESBURG PIKE, FALLS CHURCH, VA, 22041, US

(73) Assignee: BCOM ELECTRONICS INC.

(21) Appl. No.: 10/890,116

(22) Filed: Jul. 14, 2004

(51) Int. Cl. G08B 1/08; G01S 13/08; H04Q 7/20

(52) U.S. Cl. 340/539.13; 342/126; 342/139; 455/456.1

(57) ABSTRACT

A people-locating system and method make use of the UWB wireless data transmission technique in a short distance to build a people-locating system in a stationary environment. The system has at least a UWB emitter, a system controller, and at least a UWB node. Each of the UWB emitters has an ID data. The system controller is used to output a control signal. The UWB nodes are connected to the system controller and distributed in the stationary environment, and are used for receiving the control signal and emitting an inquiry signal to the UWB emitters to obtain in turn the ID data emitted by the UWB emitters.

### BACKGROUND OF THE INVENTION

1. Field of the Invention

The present invention relates to a people-locating system and method used in a stationary environment utilizing the ultra wideband (UWB) technology and, more particularly, to a people-locating system and method used in a stationary environment utilizing the UWB wireless transmission technique for data transmission.

2. Description of Related Art

Along with enhancement of living quality, modern people more and more appreciate leisure time. They usually go to some stationary environments, traveling or exercising in places such as amusement parks, parks, shopping malls, and exhibition halls. Because there is more time for parents and children to spend time together, good family relationships can be developed. In these stationary environments, however, adults may easily neglect the whereabouts of children, and lose their children. In these large stationary environments with many tourists, searching for a lost child is very difficult, and the search process is time and labor-consuming.

The ultra wideband (UWB) technology is a short-distance wireless communications technology developed by the U.S. military. Compared with other short-distance communications standards, the data rate of the 802.11b standard is only 5/1000 of that of the UWB technology. The first generation UWB technology has a transmission speed of 100 MB/s, and the second generation UWB technology has a transmission speed as high as 400 MB/s. The UWB technology is also immune to interference, accurate in positioning, and has high data transmission safety.

In order to prevent communications from being monitored by advanced wiretap techniques, the U.S. military developed the UWB technology, which was also called “invisible wave” in the past. Most wireless transmissions are accomplished with narrowband. For instance, the bandwidth used by mobile phones is about 100 MHz. The bandwidth of the UWB technology is several tens of thousands of MHz. Even if the occupied bandwidth is infiltrated, inventors of this technology claims there will be no interference because its power consumption is very low.

### SUMMARY OF THE INVENTION

An object of the present invention is to provide a people-locating system and method making use of the UWB wireless transmission technique in a short distance to build a people-locating system in a stationary environment.

The present invention is used in a stationary environment, and has at least a UWB node distributed in the stationary environment. Moreover, the short-distance wireless communications ranges of these UWB nodes are distributed in a cellular form and cover the whole stationary environment.

Moreover, these UWB nodes are connected to a system controller to receive a control signal output by the system controller. After these UWB nodes receive the control signal, the UWB wireless transmission technique is used to perform an inquiry action. These UWB nodes output inquiry signals to at least a UWB emitter located on users to obtain reply signals output by these UWB emitters, respectively. The reply signal is an ID data of the UWB emitter.

The system controller can acquire the location of a user in the stationary environment. The location is in the wireless communications range of these UWB nodes. Therefore, if a lost user is to be searched for, the system controller can be operated to output the control signal to these UWB nodes distributed in the stationary environment. These UWB nodes will output inquiry signals to obtain a reply signal output by a UWB emitter located on the lost user in the short-distance wireless communications range.

After the UWB nodes obtain a reply signal output by the UWB emitter located on the lost user, the reply signal will be sent to the system controller. The system controller will thus acquire the location of the lost user in the short-distance wireless communications range.

The various objects and advantages of the present invention will be more readily understood from the following detailed description when read in conjunction with the appended drawings, in which:

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a an operation environment diagram of a people-locating system of the present invention;

FIG. 2 is an architecture diagram of a people-locating system of the present invention;

FIG. 3 is a circuit block diagram of a UWB emitter of a people-locating system of the present invention;

FIG. 4 is a circuit block diagram of a UWB node of a people-locating system of the present invention;

FIG. 5 is a circuit block diagram of a system controller of a people-locating system of the present invention; and

FIG. 6 is a flowchart of a people-locating method of the present invention.

### DETAILED DESCRIPTION OF THE PREFERRED EMBODIMENTS

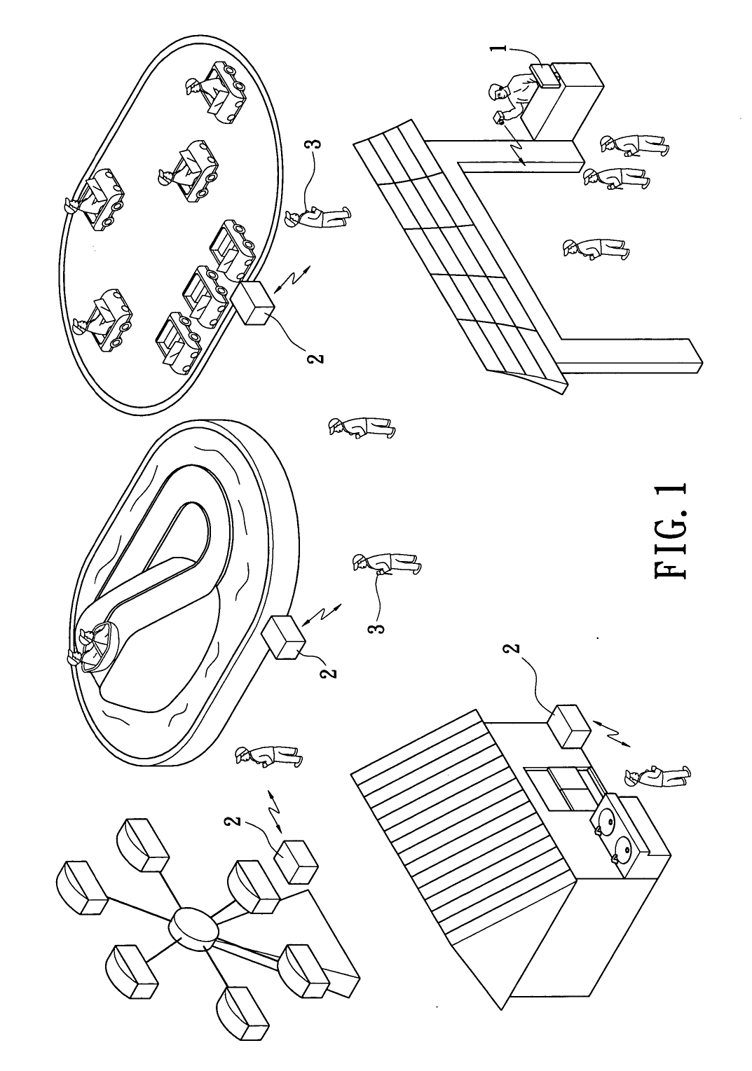

The present invention can apply to a stationary environment such as an amusement park, a shopping mall, an exhibition hall or a park. As shown in FIG. 1, the present invention applies to an amusement park. A system controller 1 is disposed at the entrance of the amusement park. UWB nodes 2 are disposed in amusement facilities and specific regions. These UWB nodes 2 are used for short-distance wireless communications, are distributed in a cellular form, and cover the whole amusement park.

After a user (a tourist) buys a ticket, he gets a UWB emitter 3 (e.g., a small decoration). An ID data is set for each UWB emitter 3. After the user gets the UWB emitter 3, an attendant uses the system controller 1 to perform a registration process for registering a user data of the UWB emitter 3 and the ID data of the UWB emitter 3.

The above user data is a start use time, an expenditure type or an expenditure process. Moreover, the attendant can get a photograph of the user via a digital still camera. The photograph data can be stored with the start use time, the expenditure type or the expenditure process in the system controller 1.

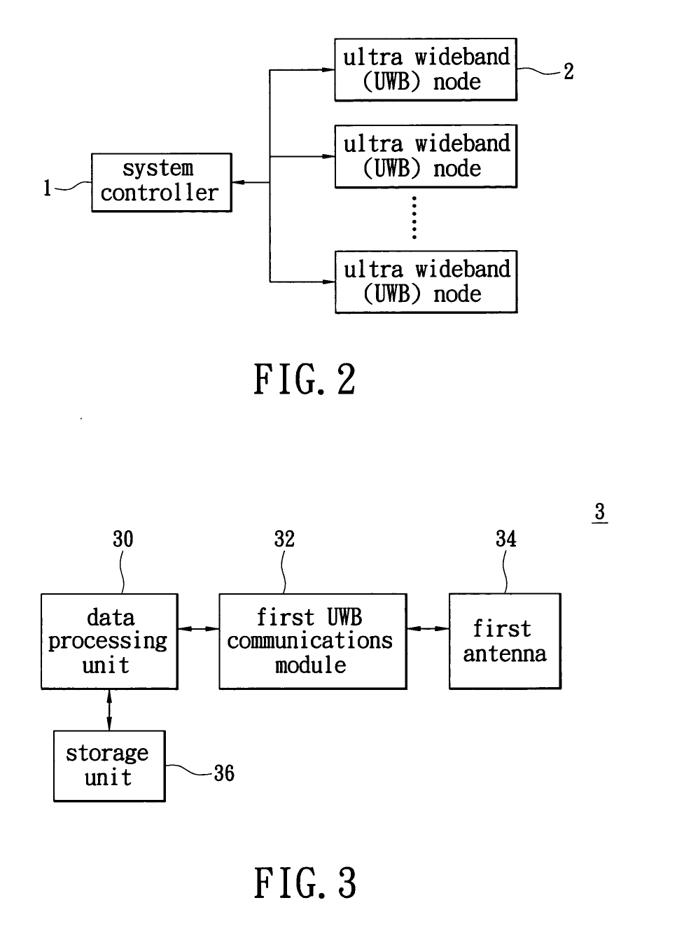

Reference is made to FIG. 2 as well as FIG. 1. The attendant uses the system controller 1 to output a control signal to at least a UWB node 2 connected with the system controller 1, thereby activating these UWB nodes to output an inquiry signal to at least a UWB emitter 3. These UWB emitters 3 are within the short-distance wireless communications range of these UWB nodes 2. These UWB nodes 2 acquire in turn the ID data emitted by these UWB emitters 3 and send the ID data to the system controller 1 at the same time.

As shown in FIG. 3, the UWB emitter 3 comprises a data processing unit 30, a first UWB communications module 32, a first antenna 34 and a storage unit 36.

The storage unit 36 of the UWB emitter 3 is connected to the data processing unit 30 and used to store an ID data. The first UWB communications module 32 connected to the data processing unit 30 receives a remote inquiry signal via the first antenna 34 and send the inquiry signal to the data processing unit 30 for digital signal processing. After processing, the data processing unit 30 sends the ID data to the first UWB communications module 32, which emits a reply signal to a remote UWB node via the first antenna 34, as shown in FIG. 2. The reply signal is the ID data.

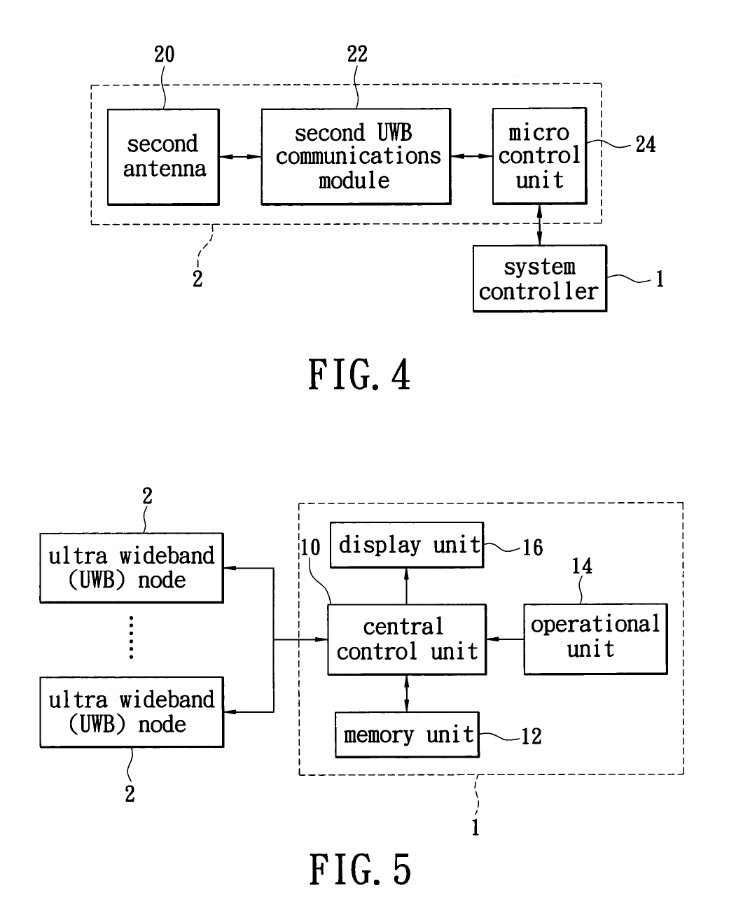

As shown in FIG. 4, the UWB node 2 comprises a second antenna 20, a second UWB communications module 22 and a micro control unit 24. The UWB node 2 is connected to the system controller 1 via the micro control unit 24. The micro control unit 24 is controlled by the system controller 1 to process digital signals. After processing, the micro control unit 24 sends the result to the second UWB communications module 22 connected to the micro control unit 24. The second UWB communications module 22 then emits an inquiry signal to a remote UWB emitter 3 via the second antenna 20, and receives a reply signal of the remote UWB emitter 3, as shown in FIG. 3.

As shown in FIG. 5, the system controller 1 comprises a central control unit 10, a display unit 16, a memory unit 12 and an operational unit 14. The system controller 1 uses the central control unit 10 to connect the UWB nodes 2, the display unit 16, the memory unit 12 and the operational unit 14. A user can send a control signal to the central control unit 10 via the operational unit 14. After the control signal is processed by the central control unit 10, it is sent to the UWB nodes 2 to activate the UWB nodes 2 to emit the inquiry signal to a remote UWB emitter 3. At the same time, the UWB nodes 2 acquire the reply signal output by the UWB emitter 3.

After the UWB nodes acquire the reply signal output by the UWB emitter 3, the reply signal is sent to the central control unit 10 and then displayed by the display unit 16 after being processed by the central control unit 10. The reply signal and the location of the UWB node 2 can thus be acquired for the object of searching for people.

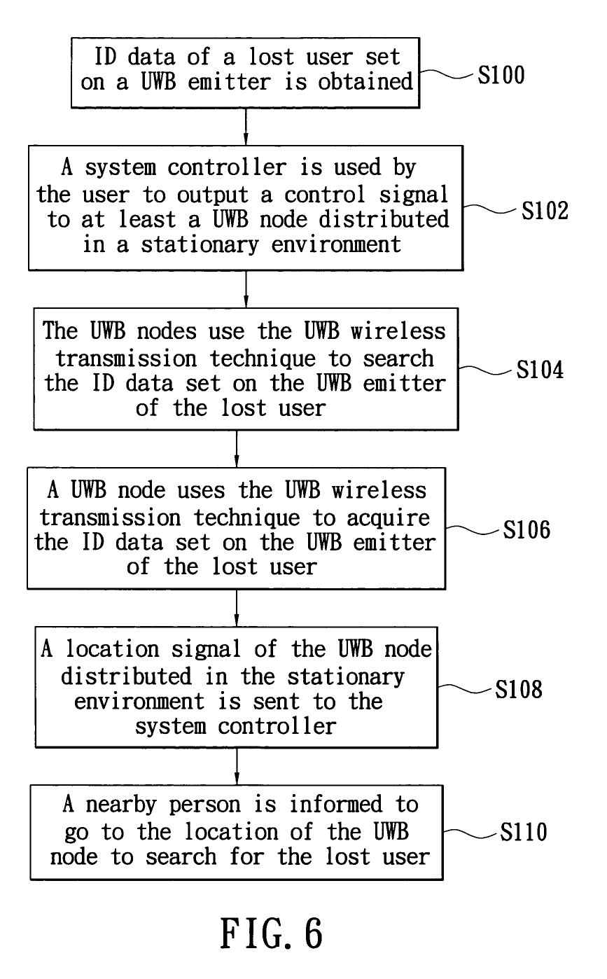

FIG. 6 is a flowchart of a people-locating method of the present invention, which comprises the following steps. When a user is declared lost, an ID data set on a UWB emitter located on the lost user is acquired (Step S100). A system controller is used to output a control signal to at least a UWB node distributed in a stationary environment (Step S102). The UWB nodes use the UWB wireless transmission technique to perform inquiry search (Step S104). Next, the UWB nodes use the UWB wireless transmission technique to acquire the ID data set on the UWB emitter located on the lost user (Step S106). A location signal of the UWB node distributed in the stationary environment and the searched ID data are sent to the system controller at the same time to reveal the location of the lost user in the stationary environment (Step S1108). Finally, a nearby person is informed to go to the location of the UWB node to search for the lost user (Step S110).

Before the above step of acquiring an ID data set on a UWB emitter located on the lost user, it is necessary to dispense the UWB emitters having ID data to users. The system controller is used to register a basic user data of the user. The registration step can be paired with a step of taking a photograph of the user via a digital still camera. When a user is declared lost, the location signal sent by the UWB nodes and the ID data along with the user data make the search easier.

Further, when the UWB nodes can't find the ID data set on the UWB emitter located on the lost user in the stationary environment, the system controller can be used to request a nearby police unit to aid in the search.

Moreover, these UWB nodes are connected to a system controller to receive a control signal output by the system controller. After these UWB nodes receive the control signal, the UWB wireless transmission technique is used to perform an inquiry action. These UWB nodes output inquiry signals to at least a UWB emitter located on users to obtain reply signals output by these UWB emitters, respectively. The reply signal is an ID data of the UWB emitter.

The system controller can acquire the location of a user in the stationary environment. The location is in the wireless communications range of these UWB nodes. Therefore, if a lost user is to be searched for, the system controller can be used to output the control signal to these UWB nodes distributed in the stationary environment. These UWB nodes will output inquiry signals to obtain a reply signal output by a UWB emitter located on the lost user in the short-distance wireless communications range.

After the UWB nodes obtain a reply signal output by the UWB emitter located on the lost user, the reply signal will be sent to the system controller. The system controller will thus acquire the location of the lost user in the short-distance wireless communications range.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A people-locating system used in a stationary environment and utilizing UWB technology, comprising:
at least a UWB emitter having an ID data, said UWB emitter utilizing the UWB technology for wirelessly emitting said ID data;
a system controller used to output a control signal; and
at least a UWB node connected to said system controller and distributed in said stationary environment, said UWB nodes being used to receive said control signal and emit an inquiry signal to said UWB emitter to obtain in turn said ID data emitted by said UWB emitters.

2. The people-locating system used in a stationary environment utilizing the UWB technology as claimed in claim 1, wherein each of said UWB emitters comprises:
a data processing unit for processing digital signals;
a storage unit connected to said data processing unit and used to store said ID data; and
a first UWB communications module connected to said data processing unit and a first antenna, said first UWB communications module receiving a remote inquiry signal via said first antenna and emitting a reply signal.

3. The people-locating system used in a stationary environment utilizing the UWB technology as claimed in claim 1, wherein each of said UWB nodes comprises:
a micro control unit for processing of digital signals; and
a second UWB communications module connected to said micro control unit and a second antenna, said second UWB communications module emitting an inquiry signal via said second antenna and receiving a remote reply signal.

4. The people-locating system used in a stationary environment utilizing the UWB technology as claimed in claim 1, wherein said system controller comprises:
a central control unit;
a memory unit connected to said central control unit for storing digital data;
an operational unit connected to said central control unit, said operational unit being used by a user to send a control signal to said central control unit; and
a display unit connected to said central control unit.

5. The people-locating system used in a stationary environment utilizing the UWB technology as claimed in claim 1, wherein said system controller can execute a registration process to register a user data using said UWB emitters and said ID data of said UWB emitters.

6. The people-locating system used in a stationary environment utilizing the UWB technology as claimed in claim 5, wherein said user data is a start time of use, an expenditure type, or an expenditure process.

7. A people-locating method used in a stationary environment utilizing the UWB technology, comprising the steps of:
obtaining an ID data of a lost user set on a UWB emitter;
outputting a control signal by a system controller to at least a UWB node distributed in a stationary environment;
searching for said ID data of said lost user by said UWB nodes;
obtaining said ID data of said lost user by one of said UWB nodes;
transmitting a location signal of said UWB node distributed in said stationary environment and said ID data of said lost user to said system controller; and
informing nearby people to go to a location of said UWB node to search for said lost user.

8. The people-locating method used in a stationary environment utilizing the UWB technology as claimed in claim 7, before said step of obtaining said ID data of said lost user by one of said UWB nodes further comprising the following steps:
dispensing said UWB emitters, each having ID data, to users; and
registering user data by said system controller.

9. The people-locating method used in a stationary environment utilizing the UWB technology as claimed in claim 7, wherein in said step of searching for said ID data of said lost user by said UWB nodes, said system controller requests search aid from a nearby police unit if said ID code is not found.

10. The people-locating method used in a stationary environment utilizing the UWB technology as claimed in claim 7, wherein a digital still camera can be used to take and register a photograph of said user in said step of registering user data by said system controller.
